(19) United States
(12) Patent Application Publication
(10) Pub. No.: US 2024/0272535 A1
(43) Pub. Date: Aug. 15, 2024

(54) PROJECTION APPARATUS

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 18/414,479

(22) Filed: Jan. 17, 2024

(30) Foreign Application Priority Data
Feb. 9, 2023 (CN) 202310087412.2

(51) Int. Cl. G03B 21/20; G03B 21/00

(52) U.S. Cl. CPC G03B 21/208; G03B 21/008; G03B 21/204

(57) ABSTRACT

A projection apparatus includes a light source module, a wedge-shaped element, a light valve, and a projection lens. The light source module provides an illumination beam. The illumination beam includes at least one of a first color light and a second color light. The wedge-shaped element is disposed on the transmission path of the illumination beam, and is configured to reflect the illumination beam. The light valve is disposed on the transmission path of the illumination beam from the wedge-shaped element, and is configured to convert the illumination beam into an image beam. The projection lens is disposed on the transmission path of the image beam, and is configured to project the image beam out of the projection apparatus. The wedge-shaped element is configured to reflect the first color light and the second color light respectively to the light valve.

### CROSS-REFERENCE TO RELATED APPLICATION

This application claims the priority benefit of China application Ser. No. 20/231,0087412.2, filed on Feb. 9, 2023. The entirety of the above-mentioned patent application is hereby incorporated by reference herein and made a part of this specification.

### BACKGROUND

### Technical Field

The disclosure relates to a display apparatus, and in particular to a projection apparatus.

### Description of Related Art

A general projection apparatus may include a light combiner, a light uniforming system, an illumination system, and a projection lens. After the light beam emitted by the light source device in the illumination system is combined by the light combiner, the light beam that passes through the light uniforming system passes through one or more lens elements, is transmitted to the light valve, and then projected to the projection screen through the projection lens. The angle distribution of the various color lights generated by the illumination system incident on the light valve affects the efficiency of the overall system and the uniformity of the projection image.

For example, for a non-telecentric illumination system, if the light source device is a structure that includes a laser light source and phosphor, and the red beam and the green beam are both generated by the phosphor and have the same light path, when the red beam and the green beam are incident on a light valve such as a digital micro-mirror device (DMD), different diffraction effects are produced due to the different wavelength ranges of the red beam and the green beam. Therefore, when the light beams exit from each area of the light valve, the difference between the angular spatial distribution of the red beam and the green beam is large, resulting in differences in image uniformity and efficiency. For example, when displaying an all-white image, it can be found that the corners of the image are reddish and the central area is greener. In addition, in this case, the projection apparatus further has the following problems: 1. The image color blocks are obvious, and the color uniformity is not good; 2. Certain aperture lenses have color cast problems such as reddish image corners; 3. The angles at which the red beam and the green beam are incident on the light valve cannot be adjusted individually.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a projection apparatus, which may effectively improve the color uniformity and color light efficiency of an image.

Other objectives and advantages of the disclosure may be further understood from the technical features disclosed in the disclosure.

To achieve one or part or all of the above-mentioned objectives or other objectives, an embodiment of the disclosure provides a projection apparatus, which includes a light source module, a wedge-shaped element, a light valve, and a projection lens. The light source module is configured to provide an illumination beam, and the illumination beam includes at least one of a first color light and a second color light. The wedge-shaped element is disposed on the transmission path of the illumination beam, and is configured to reflect the illumination beam. The light valve is disposed on the transmission path of the illumination beam from the wedge-shaped element, and is configured to convert the illumination beam into an image beam. The projection lens is disposed on the transmission path of the image beam, and is configured to project the image beam out of the projection apparatus. The wedge-shaped element has a first surface and a second surface. An included angle exists between the first surface and the second surface, and the included angle is an acute angle. The first surface and the second surface are configured to reflect the first color light and the second color light respectively, so that the first color light and the second color light are incident on the light valve at different incident angles.

Based on the aforementioned, the embodiment of the disclosure has at least one of the following advantages or effects. In the projection apparatus of the embodiment of the disclosure, since the wedge-shaped element is used to make the first color light and the second color light be incident on the light valve at different incident angles, although the wavelengths of the first color light and the second color light are different, the diffraction angle distribution of the light valve to the first color light and the second color light may be properly adjusted, thereby effectively improving the color uniformity of the image and color light efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of the light path of a first color light in a projection apparatus according to an embodiment of the disclosure.

FIG. 1B is a schematic diagram of the light path of a second color light in the projection apparatus of FIG. 1A.

FIG. 1C is a schematic perspective view of a wedge-shaped element in FIGS. 1A and 1B.

FIG. 2A is a schematic front view of a wavelength conversion wheel in FIGS. 1A and 1B.

FIG. 2B is a schematic front view of a filter wheel in FIGS. 1A and 1B.

FIGS. 3A and 3B are schematic diagrams of the angles of the first color light and the second color light incident on a light valve in FIGS. 1A and 1B respectively.

FIG. 4 is a schematic front view of a wavelength conversion wheel of a projection apparatus according to another embodiment of the disclosure.

FIG. 5A is a schematic diagram of the light path of a first color light in a projection apparatus according to yet another embodiment of the disclosure.

FIG. 5B is a schematic diagram of the light path of a second color light in the projection apparatus of FIG. 5A.

FIG. 6 is a schematic perspective view of a wedge-shaped element in a projection apparatus according to still another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

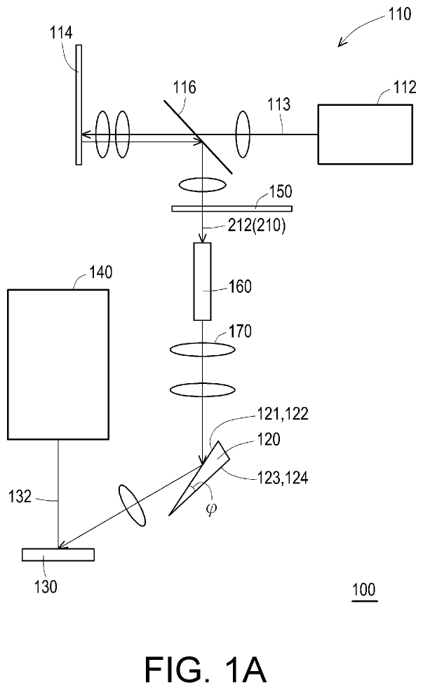

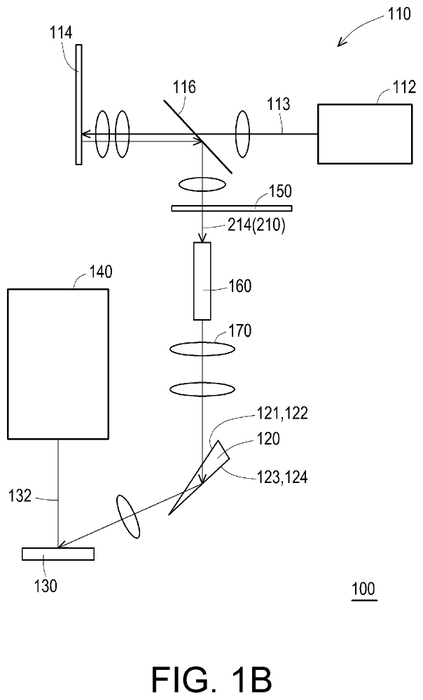

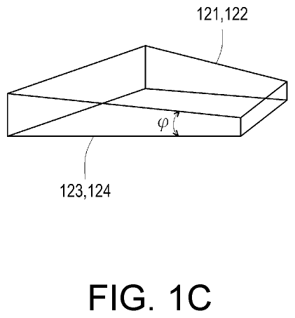

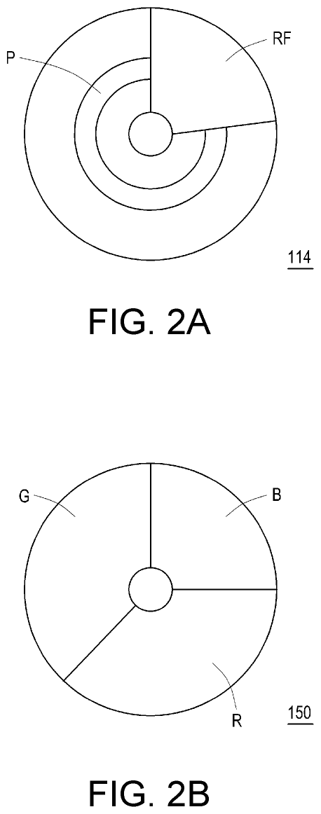

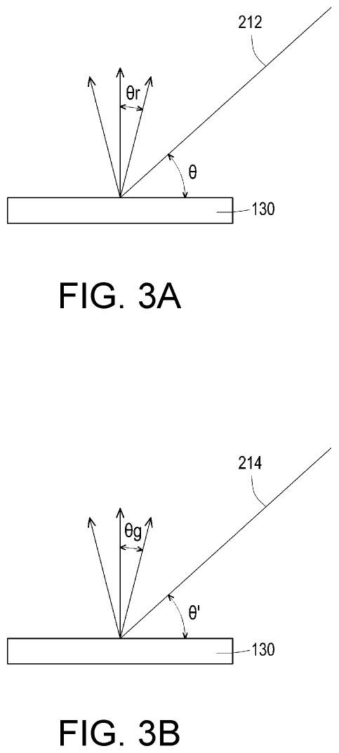

FIG. 1A is a schematic diagram of the light path of a first color light in a projection apparatus according to an embodiment of the disclosure, FIG. 1B is a schematic diagram of the light path of a second color light in the projection apparatus of FIG. 1A, and FIG. 1C is a schematic perspective view of a wedge-shaped element in FIGS. 1A and 1B. FIG. 2A is a schematic front view of a wavelength conversion wheel in FIGS. 1A and 1B, and FIG. 2B is a schematic front view of a filter wheel in FIGS. 1A and 1B. FIGS. 3A and 3B are schematic diagrams of the angles of the first color light and the second color light incident on a light valve in FIGS. 1A and 1B respectively. Referring to FIGS. 1A to 1C, 2A, 2B, 3A, and 3B, a projection apparatus 100 of the embodiment includes a light source module 110, a wedge-shaped element 120, a light valve 130, and a projection lens 140. The light source module 110 is configured to provide an illumination beam 210, and the illumination beam 210 includes at least one of a first color light 212 and a second color light 214. In the embodiment, the light source module 110 includes a laser light source 112 and a wavelength conversion wheel 114. The laser light source 112 is configured to emit a third color light 113, and the third color light 113 is a laser beam (e.g., a blue laser). In the embodiment, the laser light source 112 may include at least one laser diode or other suitable laser light sources.

The wavelength conversion wheel 114 is disposed on the transmission path of the third color light 113. The wavelength conversion wheel 114 has a wavelength conversion area P and a non-wavelength conversion area. When the wavelength conversion wheel 114 rotates, and the wavelength conversion area P enters the transmission path of the third color light 113, the wavelength conversion area P of the wavelength conversion wheel 114 is configured to convert the third color light 113 into an excited light, and the excited light includes the first color light 212 and the second color light 214. In the embodiment, the wavelength conversion wheel 114 is, for example, a phosphor wheel. The phosphor wheel includes a motor, a rotating shaft, and a disk (not shown). The rotating shaft is connected to the center of the disk, and the motor is connected to the rotating shaft to drive the rotating shaft, and further drive the disk to rotate on the rotating shaft. Thus, the wavelength conversion area P and the non-wavelength conversion area may enter the transmission path of the third color light 113 in turn. The wavelength conversion area P is located on the disk and provided with phosphor, and the phosphor is, for example, a fluorescent material that may be excited by a laser to emit yellow light. The excited light is, for example, yellow light, and the first color light 212 and the second color light 214 are, for example, red light and green light respectively. In the embodiment, the light source module 110 further includes a beam splitting unit 116. The beam splitting unit 116 is disposed on the transmission path of the third color light 113, located between the laser light source 112 and the wavelength conversion wheel 114, and adapted to guide the third color light 113 from the laser light source 112 to the wavelength conversion wheel 114. In the embodiment, the beam splitting unit 116 includes, for example, a dichroic area and a reflective area that are adjacently disposed (not shown). The dichroic area of the beam splitting unit 116 allows the third color light 113 (the blue laser) to pass through and reflect the first color light 212 and the second color light 214 (red light and green light) from the wavelength conversion area P, the reflective area of the beam splitting unit 116 is configured to reflect all light beams, and the third color light 113 emitted by the laser light source 112, for example, passes through the dichroic area of the beam splitting unit 116 and is transmitted to the wavelength conversion wheel 114. On the other hand, when the wavelength conversion wheel 114 rotates so that the non-wavelength conversion area (such as a reflective area RF) enters the transmission path of the third color light 113, the reflective area RF reflects the third color light 113 back to the beam splitting unit 116, and the reflective area of the beam splitting unit 116 reflects the third color light 113 from the reflective area RF. In the embodiment, the beam splitting unit 116 may include a dichroic mirror, a reflective mirror, a beam splitter or a combination thereof. In other embodiments, the beam splitting unit 116 includes, for example, a dichroic mirror and a reflective mirror. The reflective mirror is disposed on the transmission path of the third color light 113 reflected by the reflective area RF and passing through the dichroic mirror, so as to reflect the third color light 113. Therefore, the beam splitting unit 116 may reflect the first color light 212, the second color light 214, and the third color light 113 from the wavelength conversion wheel 114, and at least one of the first color light 212, the second color light 214, and the third color light 113 forms the illumination beam 210, that is, the illumination beam 210 may further include the third color light 113.

In the embodiment, the projection apparatus 100 further includes a filter wheel 150, which is disposed on the transmission path of the excited light (including the first color light 212 and the second color light 214) from the wavelength conversion wheel 114, and in the embodiment, for example, is disposed on the transmission path of the first color light 212, the second color light 124, and the third color light 113 from the beam splitting unit 116, and is configured to filter the excited light into the first color light 212 and the second color light 214 at different time sequences and allow the third color light 113 to pass through, thereby forming the illumination beam 210 at different time sequences. Specifically, the filter wheel 150 is adapted for rotation and has a first color area R, a second color area G, and a third color area B. The first color area R, the second color area G, and the third color area B jointly form a ring or disk shape. When the filter wheel 150 rotates, the first color area R, the second color area G, and the third color area B enter the transmission path of the corresponding color light thereof in turn at different times. The first color area R is, for example, a color filter area provided with a red color filter, the second color area G is, for example, a color filter area of a green color filter, and the third color area B is, for example, a color filter area provided with a blue color filter or an area provided with a diffuser. In the embodiment, the rotation of the filter wheel 150 is synchronous with the rotation of the wavelength conversion wheel 114. When the reflective area RF of the wavelength conversion wheel 114 enters the transmission path of the third color light 113, the third color area B of the filter wheel 150 enters the transmission path of the third color light 113 reflected by the beam splitting unit 116, and after the third color light 113 that is blue passes through the third color area B, a blue beam with a narrower wavelength band or a diffused blue beam are formed, for example. In another embodiment, the third color area B may also be replaced by a light-transmitting area, and the third color light 113 that is blue directly passes through the light-transmitting area and forms the illumination beam 210 of the time sequence.

On the other hand, when the wavelength conversion area P of the wavelength conversion wheel 114 enters the transmission path of the third color light 113, the first color area R and the second color area G of the filter wheel 150 enter the transmission path of the excited light reflected by the beam splitting unit 116 at different time sequences. The excited light is, for example, yellow, and the first color area R provided with the red color filter filters the yellow excited light into the first color light 212 that is red and forms the illumination beam 210 of the time sequence, and the second color area G provided with the green color filter filters the yellow excited light into the second color light 214 that is green and forms the illumination beam 210 of the time sequence.

In the embodiment, the projection apparatus 100 further includes a light uniforming element 160, which is disposed on the transmission path of the illumination beam 210, located between the light source module 110 and the wedge-shaped element 120, and configured to receive the first color light 212, the second color light 214, and the third color light 113 from the filter wheel 150. In the embodiment, the light uniforming element 160 is a light integrating rod, which may uniformize the passing illumination beam 210 (the first color light 212, the second color light 214, and the third color light 113). However, in other embodiments, the light uniforming element 160 may also be a lens array.

In the embodiment, the wedge-shaped element 120 of the projection apparatus 100 is disposed on the transmission path of the illumination beam 210, and is configured to reflect the illumination beam 210. The wedge-shaped element 120 is configured to receive the illumination beam 210 from the light uniforming element 160. The light valve 130 is disposed on the transmission path of the illumination beam 210 from the wedge-shaped element 120, and is configured to convert the illumination beam 210 into an image beam 132. The projection lens 140 is disposed on the transmission path of the image beam 132 from the light valve 130, and is configured to project the image beam 132 out of the projection apparatus 100, such as onto a screen or a plane, to form a projection image. In the embodiment, the light valve 130 is, for example, a digital micro-mirror device (DMD). In other embodiments, the light valve 130 may also be a liquid-crystal-on-silicon panel (LCOS panel) or other suitable spatial light modulators.

The wedge-shaped element 120 has a first surface 121 and a second surface 123, an included angle φ exists between the first surface 121 and the second surface 123, and the included angle φ is an acute angle (less than 90 degrees). The first surface 121 and the second surface 123 are configured to reflect the first color light 212 and the second color light 214 respectively, so that the first color light 212 and the second color light 214 are incident on the light valve 130 at different incident angles. As shown in FIGS. 3A and 3B, a complementary angle θ of the incident angle of the first color light 212 incident on the light valve 130 is not equal to a complementary angle θ′ of the incident angle of the second color light 214 incident on the light valve 130, that is, the incident angle (which is equal to 90°−θ) of the first color light 212 incident on the light valve 130 is not equal to the incident angle (which is equal to 90°−θ′) of the second color light 214 incident on the light valve 130. In the projection apparatus 100 of the embodiment, since the wedge-shaped element 120 is used to make the first color light 212 and the second color light 214 be incident on the light valve 130 at different incident angles, although the first color light 212 and the second color light 214 have different wavelengths, the distribution of the diffraction angle θr of the light valve 130 to the first color light 212 and the distribution of the diffraction angle θg of the light valve 130 to the second color light 214 may be properly adjusted, thereby effectively improving the color uniformity and color light efficiency of the image. In the embodiment, the projection apparatus 100 is a non-telecentric system, and the effect of the wedge-shaped element 120 on improving the image color uniformity and color light efficiency of the non-telecentric system is particularly obvious, because in the non-telecentric system, the first color light 212 and the second color light 214 are incident on the light valve 130 at more different angles.

In addition, in the projection apparatus 100 of the embodiment, since the wedge-shaped element 120 is used to properly deflect the light beam, such spatial arrangement helps reduce the volume of the projection apparatus.

In the embodiment, the first surface 121 of the wedge-shaped element 120 is provided with a dichroic film 122, and the second surface 123 is provided with a reflective film 124. The first color light 212 is reflected by the dichroic film 122 to the light valve 130 (as shown in FIG. 1A), the second color light 214 sequentially passes through the dichroic film 122, is reflected by the reflective film 124, and is transmitted to the light valve 130 after passing through the dichroic film 122 again. In addition, the third color light 113 may also follow the path of the second color light 214, sequentially pass through the dichroic film 122, be reflected by the reflective film 124, and be transmitted to the light valve 130 after passing through the dichroic film 122 again. In other words, the dichroic film 122 is adapted to reflect the first color light 212, and is adapted to allow the second color light 214 and the third color light 113 to pass through, that is, the dichroic film 122 reflects red light (the first color light) and allows green light (the second color light) and blue light (the third color light) to pass through. In the embodiment, the thickness between the first surface 121 and the second surface 123 of the wedge-shaped element 120 gradually increases along a direction away from the light valve 130. In addition, the wedge-shaped element 120 is, for example, a prism of a transparent material. In this way, the effect of making the first color light 212 and the second color light 214 be incident on the light valve 130 at different incident angles may be achieved by using the wedge-shaped element 120.

In other embodiments, the first color light 212 may also be green light, and the second color light 214 may be red light, that is, the dichroic film 122 reflects green light (the first color light) and allows red light (the second color light) and blue light (the third color light) to pass through. In other words, in these embodiments, one of the first color light 212 and the second color light 214 may also be red light, and the other one of the first color light 212 and the second color light 214 is green light.

In addition, the projection apparatus 100 may be properly provided with one or more lenses 170 in the light path from the laser light source 112 to the light valve 130 to achieve a good light transmission effect.

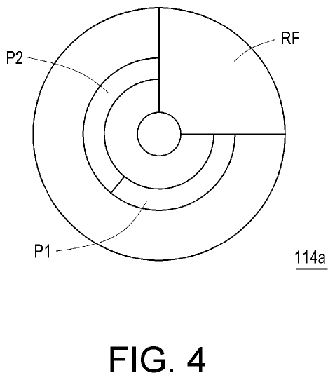

FIG. 4 is a schematic front view of a wavelength conversion wheel of a projection apparatus according to another embodiment of the disclosure. Referring to FIGS. 1A, 1B, and 4, a wavelength conversion wheel 114a of the embodiment may be configured to replace the wavelength conversion wheel 114 in FIGS. 1A and 1B and form a projection apparatus in another embodiment. In the embodiment, the wavelength conversion wheel 114a has the reflective area RF, a first wavelength conversion area P1, and a second wavelength conversion area P2. The reflective area RF, the first wavelength conversion area P1, and the second wavelength conversion area P2 may enter the transmission path of the third color light 113 at different time sequences. The first wavelength conversion area P1 is configured to convert the third color light 113 into a first excited light, the second wavelength conversion area P2 is configured to convert the third color light 113 into a second excited light, and the reflective area RF is configured to reflect the third color light 113. In addition, the filter wheel 150 is disposed on the transmission path of the third color light, the first excited light, and the second excited light from the wavelength conversion wheel 114a, and is configured to allow the third color light 113 to pass through, filter the first excited light into the first color light 212, and filter the second excited light into the second color light 214 at different time sequences. Specifically, red phosphor is disposed in the first wavelength conversion area P1, for example, the first excited light is red light, and the first color area R provided with the red color filter filters the first excited light that is red into the first color light 212 with a purer color (narrower wavelength band), and further forms the illumination beam of the time sequence. In addition, green phosphor is disposed in the second wavelength conversion area P2, for example, the second excited light is green light, and the second color area G provided with the green color filter filters the second excited light that is green into the second color light 214 with a purer color (narrower wavelength band), and further forms the illumination beam of the time sequence. The third color light 113 that is blue from the reflective area RF passes through the third color area B and forms the illumination beam of the time sequence.

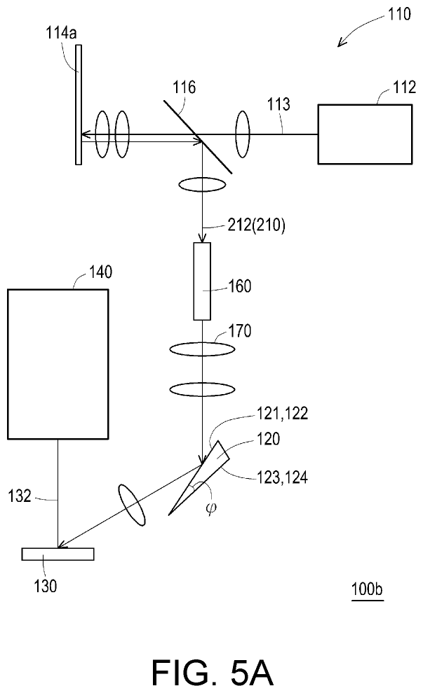

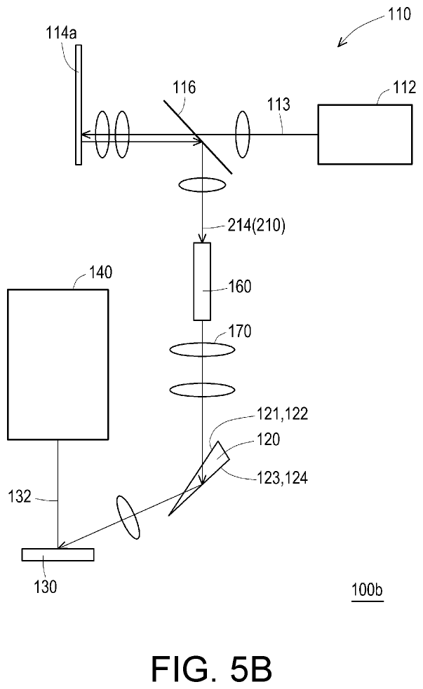

FIG. 5A is a schematic diagram of the light path of a first color light in the projection apparatus according to yet another embodiment of the disclosure, and FIG. 5B is a schematic diagram of the light path of a second color light in the projection apparatus of FIG. 5A. Referring to FIGS. 5A and 5B, a projection apparatus 100b of the embodiment is similar to the projection apparatus 100 in FIGS. 1A and 1B, and the differences between the two are as follows. The projection apparatus 100b of the embodiment uses the wavelength conversion wheel 114a of FIG. 4 to replace the wavelength conversion wheel in FIGS. 1A and 1B, and the projection apparatus 100b of the embodiment does not have the filter wheel 150 in FIGS. 1A and 1B. As described in the embodiment of FIG. 4, the first excited light may be red, and the second excited light may be green. Therefore, the first excited light may also be directly regarded as the first color light 212, the second excited light is regarded as the second color light 214, and after being reflected by the beam splitting unit 116, the first excited light and the second excited light directly enter the light uniforming element 160 without passing through the filter wheel.

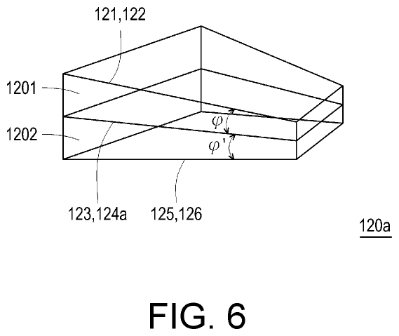

FIG. 6 is a schematic perspective view of a wedge-shaped element in a projection apparatus according to still another embodiment of the disclosure. Referring to FIGS. 1A, 1B, and 6, a wedge-shaped element 120a in FIG. 6 may be configured to replace the wedge-shaped element 120 in FIGS. 1A and 1B to form a projection apparatus according to still another embodiment of the disclosure. The wedge-shaped element 120a of the embodiment is similar to the wedge-shaped element 120 of FIG. 1C, and the differences between the two are as follows. The wedge-shaped element 120a of the embodiment further has a third surface 125, the second surface 123 is located between the first surface 121 and the third surface 125, and the third surface 125 is configured to reflect the third color light 113 to the light valve 130.

The wedge-shaped element 120a includes a first sub-prism 1201 and a second sub-prism 1202, the second surface 123 is the interface between the first sub-prism 1201 and the second sub-prism 1202, the first surface 121 is the surface of the first sub-prism 1201 facing away from the second sub-prism 1202, and the third surface 125 is the surface of the second sub-prism 1202 facing away from the first sub-prism 1201. The first surface 121 of the wedge-shaped element 120a is provided with the dichroic film 122 (a first dichroic film), the second surface 123 is provided with another dichroic film 124a (a second dichroic film), and the third surface 125 is provided with a reflective film 126.

The first color light 212 is reflected by the dichroic film 122 of the first surface 121 to the light valve 130. The second color light 214 sequentially passes through the dichroic film 122 of the first surface 121, is reflected by the dichroic film 124a of the second surface 123, and is transmitted to the light valve 130 after passing through the dichroic film 122 of the first surface 121 again. The third color light 113 sequentially passes through the dichroic film 122 of the first surface 121, passes through the dichroic film 124a of the second surface 123, is reflected by the reflective film 126 of the third surface 125, and is transmitted to the light valve 130 after passing through the dichroic film 124a of the second surface 123 again and passing through the dichroic film 122 of the first surface 121. That is, in the embodiment, the dichroic film 122 is adapted to reflect the first color light 212 and is adapted to allow the second color light 214 and the third color light 113 to pass through. The dichroic film 124a is adapted to reflect the second color light 214 and is adapted to allow the third color light 113 to pass through.

An acute angle (that is, the included angle φ) exists between the first surface 121 and the second surface 123 of the wedge-shaped element 120a, and another acute angle (that is, an included angle φ′) exists between the third surface 125 and the second surface 123 of the wedge-shaped element. In an embodiment, the acute angle (that is, the included angle φ) between the first surface 121 and the second surface 123 is not equal to the another acute angle (that is, the included angle φ′) between the third surface 125 and the second surface 123. In an embodiment, the thickness between the first surface 121 and the second surface 123 of the wedge-shaped element 120a gradually increases along the direction away from the light valve 130, and the thickness between the third surface 125 and the second surface 123 also gradually increases along the direction away from the light valve 130.

With the above design, the first color light 212, the second color light 214, and the third color light 113 can respectively be incident on the effective imaging area of the light valve 130 at different angles, so that the diffraction angle distribution of the light valve 130 to the first color light 212, the second color light 214, and the second color light 113 is properly adjusted, thereby effectively improving the color uniformity of the image and color light efficiency.

One of the first color light 212, the second color light 214, and the third color light 113 is red light, another one of the first color light 212, the second color light 214, and the third color light 113 is green light, and the other one of the first color light 212, the second color light 214, and the third color light 113 is blue light. In the embodiment, the first color light 212 is red light, the second color light 214 is green light, and the third color light 113 is blue light as an example.

In summary, the embodiment of the disclosure has at least one of the following advantages or effects. In the projection apparatus of the embodiment of the disclosure, since the wedge-shaped element is used to make the first color light and the second color light be incident on the light valve at different incident angles, although the wavelengths of the first color light and the second color light are different, the diffraction angle distribution of the light valve to the first color light and the second color light may be properly adjusted, thereby effectively improving the color uniformity of the image and color light efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus, comprising: a light source module, a wedge-shaped element, a light valve, and a projection lens; wherein
the light source module is configured to provide an illumination beam, wherein the illumination beam comprises at least one of a first color light and a second color light;
the wedge-shaped element is disposed on a transmission path of the illumination beam, and is configured to reflect the illumination beam;
the light valve is disposed on a transmission path of the illumination beam from the wedge-shaped element, and is configured to convert the illumination beam into an image beam; and
the projection lens is disposed on a transmission path of the image beam, and is configured to project the image beam out of the projection apparatus;
wherein the wedge-shaped element has a first surface and a second surface, an included angle exists between the first surface and the second surface, the included angle is an acute angle, and the first surface and the second surface are configured to reflect the first color light and the second color light respectively, so that the first color light and the second color light are incident on the light valve at different incident angles.

2. The projection apparatus according to claim 1, wherein the first surface of the wedge-shaped element is provided with a dichroic film, the second surface is provided with a reflective film, the first color light is reflected by the dichroic film to the light valve, and the second color light sequentially passes through the dichroic film, is reflected by the reflective film, and is transmitted to the light valve after passing through the dichroic film again.

3. The projection apparatus according to claim 1, wherein a thickness between the first surface and the second surface of the wedge-shaped element gradually increases along a direction away from the light valve.

4. The projection apparatus according to claim 1, further comprising a light uniforming element, disposed on the transmission path of the illumination beam and located between the light source module and the wedge-shaped element.

5. The projection apparatus according to claim 4, wherein the light uniforming element is a light integrating rod.

6. The projection apparatus according to claim 1, wherein the projection apparatus is a non-telecentric system.

7. The projection apparatus according to claim 1, wherein the light valve is a digital micro-mirror device.

8. The projection apparatus according to claim 1, wherein the light source module comprises: a laser light source and a wavelength conversion wheel; wherein
the laser light source is configured to emit a third color light, wherein the third color light is a laser beam; and
the wavelength conversion wheel is disposed on a transmission path of the third color light, the wavelength conversion wheel has a wavelength conversion area, and the wavelength conversion area is configured to convert the third color light into an excited light, wherein the excited light comprises the first color light and the second color light.

9. The projection apparatus according to claim 8, further comprising a filter wheel, disposed on a transmission path of the excited light from the wavelength conversion wheel, and configured to filter the excited light into the first color light and the second color light at different time sequences.

10. The projection apparatus according to claim 8, wherein the light source module comprises: a laser light source and a wavelength conversion wheel; wherein
the laser light source is configured to emit a third color light, wherein the third color light is a laser beam; and
the wavelength conversion wheel is disposed on a transmission path of the third color light, the wavelength conversion wheel has a first wavelength conversion area and a second wavelength conversion area, the first wavelength conversion area is configured to convert the third color light into a first excited light, and the second wavelength conversion area is configured to convert the third color light into a second excited light.

11. The projection apparatus according to claim 10, further comprising a filter wheel, disposed on a transmission path of the first excited light and the second excited light from the wavelength conversion wheel, and configured to filter the first excited light into the first color light and filter the second excited light into the second color light at different time sequences.

12. The projection apparatus according to claim 1, wherein the wedge-shaped element further has a third surface, the second surface is located between the first surface and the third surface, the illumination beam further comprises a third color light, and the third surface is configured to reflect the third color light to the light valve.

13. The projection apparatus according to claim 12, wherein the wedge-shaped element comprises a first sub-prism and a second sub-prism, the second surface is an interface between the first sub-prism and the second sub-prism, the first surface is a surface of the first sub-prism facing away from the second sub-prism, and the third surface is a surface of the second sub-prism facing away from the first sub-prism.

14. The projection apparatus according to claim 12, wherein the first surface of the wedge-shaped element is provided with a first dichroic film, the second surface is provided with a second dichroic film, and the third surface is provided with a reflective film.

15. The projection apparatus according to claim 14, wherein the first color light is reflected by the first dichroic film to the light valve, the second color light sequentially passes through the first dichroic film, is reflected by the second dichroic film, and is transmitted to the light valve after passing through the first dichroic film again, and the third color light sequentially passes through the first dichroic film, passes through the second dichroic film, is reflected by the reflective film, and is transmitted to the light valve after passing through the second dichroic film again and passing through the first dichroic film.

16. The projection apparatus according to claim 12, wherein another acute angle exists between the third surface and the second surface of the wedge-shaped element.

17. The projection apparatus according to claim 16, wherein the acute angle between the first surface and the second surface is not equal to the another acute angle between the third surface and the second surface.

18. The projection apparatus according to claim 12, wherein the first color light, the second color light, and the third color light are respectively incident on an effective imaging area of the light valve at different angles.

19. The projection apparatus according to claim 12, wherein one of the first color light, the second color light, and the third color light is red light, another one of the first color light, the second color light, and the third color light is green light, and the other one of the first color light, the second color light, and the third color light is blue light.

20. The projection apparatus according to claim 1, wherein one of the first color light and the second color light is red light, and the other one of the first color light and the second color light is green light.
